(19) United States
(12) Patent Application Publication
(10) Pub. No.: US 2017/0120524 A1
(43) Pub. Date: May 4, 2017

(54) INTEGRATED THREE-DIMENSIONAL MANUFACTURING EQUIPMENT FOR MAKING 3D MODELS

(71) Applicant: Shanghai Xinjian Medical Co., LTD., Shanghai City (CN)

(72) Inventor: FEI LIU, Shanghai City (CN)

(21) Appl. No.: 15/343,051

(22) Filed: Nov. 3, 2016

(30) Foreign Application Priority Data
Nov. 3, 2015 (CN) 201510735286.2

(51) Int. Cl. B29C 67/00; B33Y 30/00

(52) U.S. Cl. CPC B29C 67/0085; B33Y 30/00

(57) ABSTRACT

An integrated 3D manufacturing equipment comprises a housing, a printer and a computer both receiving in the housing. The computer is connected to the printer and located under the printer.

### BACKGROUND OF THE INVENTION

1. Field of the Invention

The present invention relates to an integrated three-dimensional manufacturing equipment for making 3D objects, and more particularly to an integrated three-dimensional printer using an additive extrusion type manufacturing build process.

2. Description of the Prior Art

The use of geometry from three-dimensional (3D) computer aided drafting (CAD) models has been used in conjunction with 3D manufacturing equipment for the purpose of manufacturing prototypes for years. The 3D manufacturing equipment fits into two major categories where the older of two categories involved removal or cutting away of material from a solid block of material such as a CNC (computer numerical control) machine where the solid block is clamped in placed within and material is cut away until the remaining material represents the CAD geometry supplied to the CNC machine. Instead of starting with a volume of material and removing material to create the designed 3D geometry, the newer technology uses an additive process where the 3D CAD model is cut into layers in software and the 3D object is built layer by layer within a build plane until the desired geometry represents the 3D object in the CAD model. The 3D manufacturing equipment (3D Printer) used for this newer technology builds the 3D object by adhering a layer of material to a build plate, then by adhering each consecutive layer to the previous layer in a plane parallel to the build plate within the 3D Printer until the 3D object's geometry matches the 3D CAD geometry provided to the 3D Printer.

Although the 3D objects reconstructed by the CAD software installed in the computer can be printed by the 3D manufacturing equipment through a mobile storage device copy the CAD models of the 3D objects to the 3D manufacturing equipment, accommodating the 3D manufacturing equipment and the computer needs a large place because of the 3D manufacturing equipment and the computer being installed in different rooms. And copying the CAD models of the 3D objects from the computer to the 3D manufacturing equipment is time-consuming and mistakes maybe happen at the same time.

Accordingly, an integrated 3D manufacturing equipment for manufacturing 3D models that solves the above problems is desirable.

### SUMMARY OF THE INVENTION

In accordance with the present invention, an integrated 3D manufacturing equipment is provided to minimize an accommodative space and save time.

In order to achieve the object set forth, an integrated 3D manufacturing equipment for printing 3D models comprises a housing with a 3D printer assembled therein, and a computer accommodated in the housing and connected to the 3D printer. The computer is located under the 3D printer.

Other objects, advantages and novel features of the present invention will become more apparent from the following detailed description when taken in conjunction with the accompanying drawings, in which:

### BRIEF DESCRIPTION OF THE DRAWINGS

FIG. 1 is an assembled, perspective view of an integrated 3D manufacturing equipment in accordance with the preferred embodiment of the present invention;

FIG. 2 is a perspective view of the integrated 3D manufacturing equipment without a display assembled thereon shown in FIG. 1;

FIG. 3 is a perspective view of the integrated 3D manufacturing equipment having a housing with two open doors shown in FIG. 2;

FIG. 4 is a perspective view of the integrated 3D manufacturing equipment having the housing without a baffle assembled thereon shown in FIG. 3;

FIG. 5 is an exploded, perspective view of the integrated 3D manufacturing equipment shown in FIG. 4;

FIG. 6 is a perspective view of the housing of the integrated 3D manufacturing equipment shown in FIG. 3; and

FIG. 7 is a perspective view of the housing of the integrated 3D manufacturing equipment shown in FIG. 4.

### DESCRIPTION OF PREFERRED EMBODIMENTS OF THE INVENTION

Reference is now made to the drawings to describe the invention in detail.

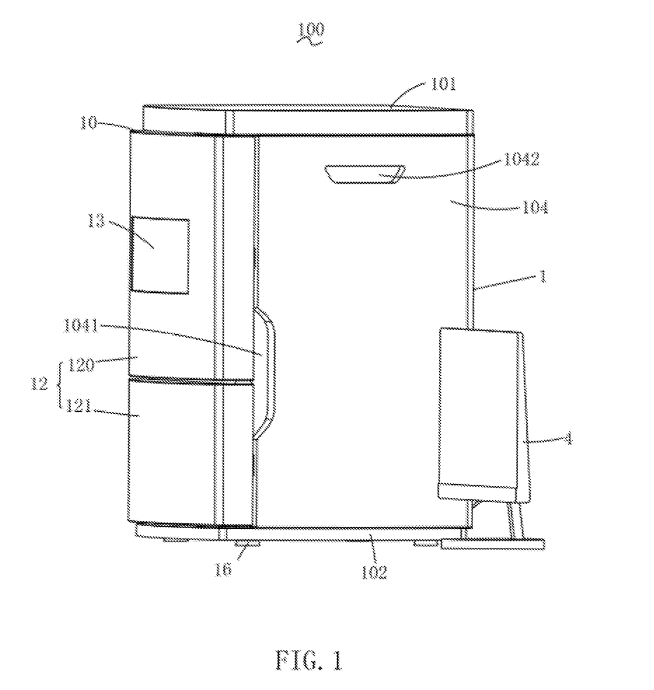

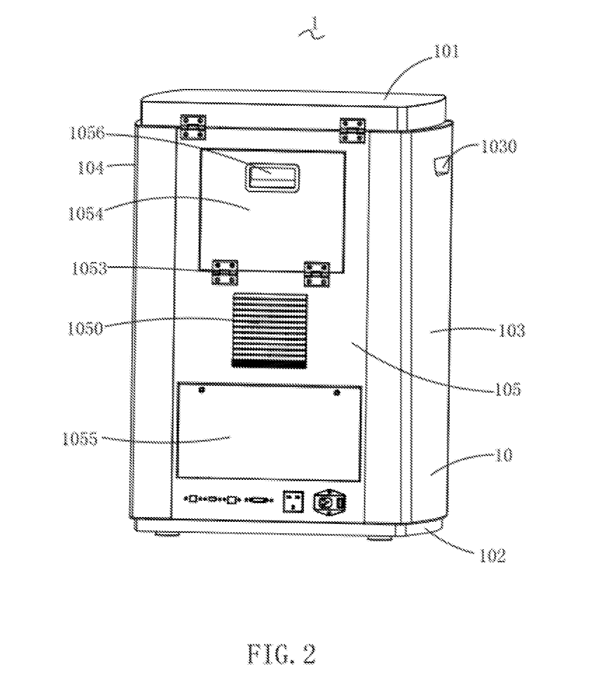

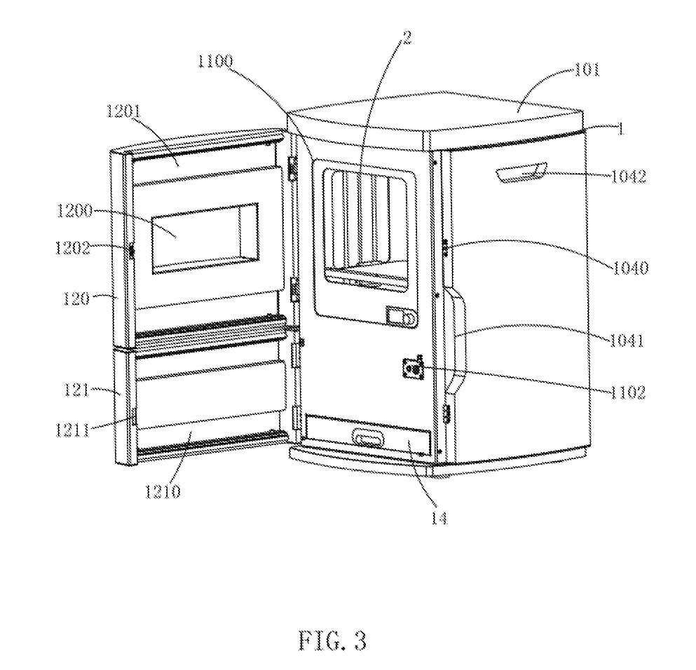

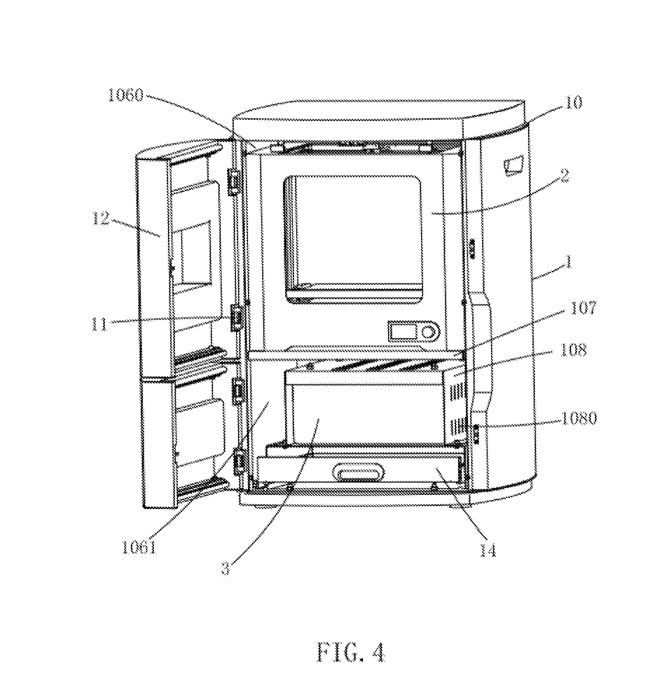

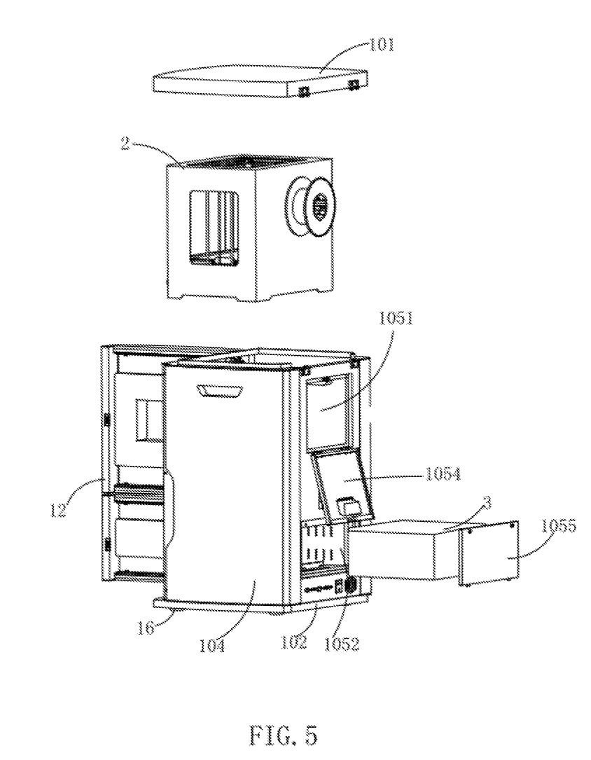

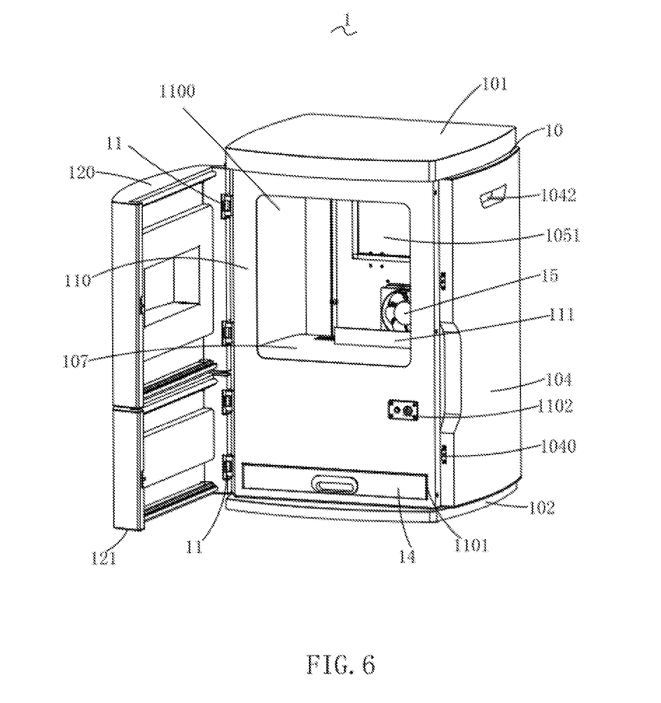

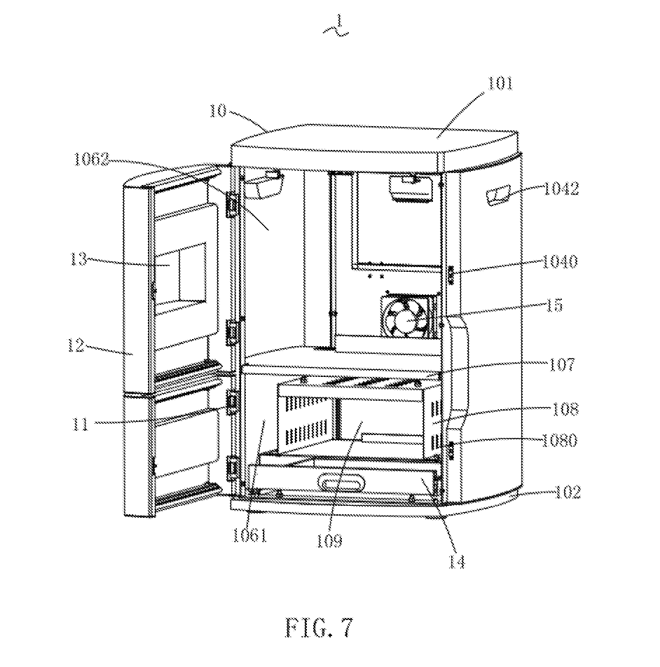

As illustrated in FIGS. 1-7, a preferred embodiment of this invention provides an integrated 3D manufacturing equipment 100 for manufacturing 3D models. The integrated 3D manufacturing equipment 100 comprises a housing 1, a printer 2 mounted in the housing 1, a computer 2 assembled in the housing 1 and a display 4 connected with the computer 3. The printer 2 is connected to the computer 3 and can manufacture a 3D object (not shown) through an additive process under the control of the computer 3. The computer 3 can transmit the 3D model (not shown) reconstructed from an imaging data to the printer 2.

The housing 1 for accommodating the printer 2 and the computer 3 comprises a box 10 surrounded by metal sheets, first and second doors 12 pivoted on the box 10 through a shaft 11, a transparent board 13 assembled on the first door 120, a drawer 14 mounted on a bottom of the box 10, a fan 15 located on a sidewall of the box 10 and four gasket 16 located at four corners of the box 10. The box 10 configured with a cuboid shape includes a top cover 101 with a horizontal plate-shape, a bottom plate 102 opposite to the top cover 101, a left-side plate 103 sandwiched between the top cover 101 and the bottom plate 102, a right-side plate 104 opposite to the left-side plate 103 and a rear side plate 105 connecting the left-side plate 103 and the right-side plate 104. The right-side plate 104 and the rear side plate 105 are sandwiched between the top cover 101 and the bottom plate 102. The left-side plate 103, the rear side plate 105 and the right-side plate 104 are assembled together in order through a plurality of screw bolts (not shown). The box 10 also has a receiving cavity 106 surrounded thereby for receiving the printer 2 and the computer 3.

A horizontal loading board 107 is arranged between the top cover 101 and the bottom plate 102. The receiving cavity 106 is divided into a first cavity 1060 and a second cavity 1061 by the loading board 107. The first cavity 1060 for receiving the printer 2 is located above the second cavity 1061 used for receiving the computer 3 and the drawer 14. The first cavity 1060 is surrounded by an upper portion of the box 10 and the loading board 107. The second cavity 1061 is formed by a lower portion of the box 10 and the loading board 107. The box 10 has a barrier plate 111 vertically located on the loading board 107. The barrier plate 111 is mounted on a portion of the loading board 107 near the rear side plate 105.

The left-side plate 103 has one side pivoted with the first door 120 through the shaft 11 and the other side connected with the rear side plate 105. A first holding groove 1030 is sunk from an outer surface 1031 of the left-side plate 103. The right-side plate 104 has two magnetic catches 1040 assembled on one side thereof and a handle groove 1041 located between the magnetic catches 1040 for receiving a hand of an operator. The right-side plate 104 also defines a second holding groove 1042 corresponding to the first holding groove 1030. The rear side plate 105 has a plurality of ventilation slots 1050 for exchanging heat, an upper opening 1051 located above the ventilation slots 1050 for changing material of the printer 2 and a lower opening 1052 located below the ventilation slots 1050. The rear side plate 105 has a closing plate 1054 pivoted thereto through two jointed shaft 1053. The closing plate 1054 having a faster 1056 located thereon can be rotated is pivoted to a portion of the rear side plate 105 for opening of closing the upper opening 1050 through the jointed shafts 1053. A cover plate 1055 is mounted on a portion of the rear side plate 105 corresponding to the lower opening 105 through the screw bolts (not shown).

The bottom plate 102 defines two sliding guides (not labeled) located at two sides thereof and matching with the drawl 14. The sliding guides (not labeled) are located in the second receiving cavity 1061 of the box 10. The drawl 14 for storing printing-supplies or other things can slide along the sliding guides (not labeled) toward to or away from the rear side plate 105 in a front-to-rear direction. A fasten frame 108 with a lots of heating slots 1080 is located above the drawl 14. An accommodating chamber 109 is defined by the fasten frame 108 and the drawl 14 for accommodating the computer 3. The fasten frame 108 is located in the second receiving cavity 1061. The fan 15 is assembled on the rear side plate 105 corresponding to the ventilation slots 1050 and received in the first receiving cavity 1060. The fan 15 is used for adjusting the temperature in the first receiving cavity 1060 to make sure the printer 2 being worked in a constant temperature condition.

The box 10 also has a front side plate 110 opposite to the rear side plate 105. The front side plate 110 connects the top cover 101 to the bottom plate 102 through a top and a bottom thereof. The front side plate 110 connects the left-side plate 103 to the right-side plate 104 through two sides thereof. The front side plate 110 is parallel to the rear side plate 105 and located between the doors 12 and the rear side plate 105. A movement of the printer 2 along the front-to-rear direction in the first receiving cavity 1060 is limited by a top portion of the front side plate 110 and the barrier plate 111. A movement of the computer 3 along the front-to-rear direction in the accommodating chamber 109 is limited through a lower portion of the front side plate 110 matching with the cover plate 1055 mounted on the rear side plate 105. The front side plate 110 has a hollow 1100 for watching the working condition of the printer 2 and removing the 3D object from the printer 2. The front side plate 110 also has a through hole 1101 corresponding to the drawl 14. The through hole 1101 is used for the drawl 14 passing through. A button 1102 is located on the front side plate 110 for putting on the computer 3.

The shafts 11 are fastened to the side of the left-side plate 103. The first door 120 and the second door 121 can rotate along the shafts 11 relative to the box 10 to open of close the box 10. The first door 120 is located above the second door 121. The first door 120 is assembled corresponding to the first receiving cavity 1060 and the second door 121 is assembled corresponding to the second receiving cavity 1061. The first door 120 defines a window 1200 with an arc-shape corresponding to the hollow 1100 of the front side plate 110. The first door 1200 has a reinforcing rib 1201 for improving the strength thereof. a first clamping pin 1202 is defined on the side of the first door 120 and can match with the corresponding magnetic catches 1040 located above the handle groove 1041 to close the first receiving cavity 1060 of the box 10. The second door 121 has a stiffener 1210 with an arched shape to reinforce the strength thereof. A second clamping pin 1211 is defined on the side of the second door 1221 and can engage with the magnetic catches 1040 located under the handle groove 1041 to fasten the second door 121 to the box 10.

Furthermore, although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An integrated three-dimensional (3D) manufacturing equipment comprising:
a housing;
a printer mounted in the housing;
a computer mounted in the housing and connected to the printer; and
wherein the computer is located under the printer.

2. The integrated 3D manufacturing equipment of claim 1, wherein the housing includes a box defining a receiving cavity for receiving the printer and the computer and door assembly pivoted to the box through a plurality of shaft.

3. The integrated 3D manufacturing equipment of claim 2, wherein the box has a loading board dividing the receiving cavity into a first receiving cavity for receiving the printer and a second receiving cavity for receiving the computer, and wherein the first receiving cavity is located above the second receiving cavity.

4. The integrated 3D manufacturing equipment of claim 3, wherein the housing includes a drawl assembled on the box, and wherein the drawl is located in the second receiving cavity and mounted under the computer.

5. The integrated 3D manufacturing equipment of claim 3, wherein the housing has a fan assembled on the box, and wherein the fan is located in the first receiving cavity, and wherein the box has a plurality of ventilation slots corresponding to the fan.

6. The integrated 3D manufacturing equipment of claim 3, wherein the door assembly includes a first door corresponding to the first receiving cavity and a second door corresponding to the second receiving cavity.

7. The integrated 3D manufacturing equipment of claim 6, wherein the housing defines a front side plate sandwiched between the door assembly and the box, and wherein the front side plate has a hollow corresponding to the first receiving cavity and a through hole corresponding to the drawl.

8. The integrated 3D manufacturing equipment of claim 7, wherein the first door has a window corresponding to the hollow of the front side plate, and wherein the housing includes a transparent board mounted to cover the window of the first door.

9. The integrated 3D manufacturing equipment of claim 5, wherein the box has an upper opening located above the ventilation slots and a closing plate pivoted thereto through jointed shafts for opening or closing the upper opening.

10. The integrated 3D manufacturing equipment of claim 9, wherein the box has a lower opening located under the ventilation slots and a cover plate fastened thereto through screw bolts for closing the lower opening.

11. The integrated 3D manufacturing equipment of claim 2, wherein the box has a plurality of magnetic catches assembled thereto, and wherein the door assembly has a plurality of clamping pins assembled thereon to engage with the corresponding magnetic catches.

12. The integrated 3D manufacturing equipment of claim 11, wherein the door assembly defines a plurality of reinforcing rib mounted thereon, and wherein the box has a barrier plate vertically mounted on the loading plate to abut the printer.

13. The integrated 3D manufacturing equipment of claim 1, wherein the integrated 3D manufacturing equipment comprises a display connected to the computer.
